(19) United States
(12) Patent Application Publication
(10) Pub. No.: US 2008/0112750 A1
(43) Pub. Date: May 15, 2008

(54) Pack

(76) Inventor: Kathleen Amanda Thomson, Suffolk (GB)

Correspondence Address: WORKMAN NYDEGGER, 60 EAST SOUTH TEMPLE, 1000 EAGLE GATE TOWER, SALT LAKE CITY, UT, 84111, US

(21) Appl. No.: 11/722,671

(22) PCT Filed: Dec. 22, 2005
(86) PCT No.: PCT/GB05/05046

§ 371 Date: Jun. 22, 2007

(30) Foreign Application Priority Data
Dec. 23, 2004 (GB) 0428220.8

(51) Int. Cl. B05C 17/00; B05C 17/10; A45D 33/00

(52) U.S. Cl. 401/132; 401/261; 401/130

(57) ABSTRACT

A pack having a produce containing portion and a spatula which in use is joined to said produce containing portion; the spatula being an extension of a wall of the produce containing portion which extends in use beyond the periphery of the produce containing portion. The produce containing portion is a squeeze-pack incorporating one or more fold lines which allow the pack to be collapsed on itself about said lines in concertina fashion when a user squeezes the pack. Alternatively, the pack incorporates a peripheral flange; the spatula being an extension of the peripheral flange and incorporating structure for reinforcing the spatula.

### FIELD OF THE INVENTION

This invention relates to packs generally which may have particular advantageous applications in the food industry. However, any application outside of the food industry is also envisaged. The pack may, for example, be used as a pack for housing adhesive, for housing cosmetic products such as a hair bleaching chemical, a medical solution which may require application to the human body in a sterile environment or even a food decorative produce such as icing.

### BACKGROUND TO THE INVENTION AND PRIOR ART KNOWN TO THE APPLICANT(S)

Systems with integral spreaders exist such as correction fluid containers, one example of which is sold under the well-known brand name Tippex. Another form of integral spreader system is a paper glue container whose cap is sufficiently flexible to act as a spreader.

These prior art systems have a number of drawbacks, one being that the spreader is entirely separate from the produce containing portion of the packs. These are usually constructed to be either cleanable or kept sufficiently clean or unspoilt so that these prior art containers may be used several times. These therefore were often prone to rapid deterioration. Nowadays, these multiple-use packs with integral spreader devices have improved by chemical modifications to the actual produce and design of the spreaders. For example, a typical correction fluid pack will now often incorporate a modified whitening compound whilst the spreading tip has been changed from a brush to a porous wedge-shaped sponge.

Examples of packs were identified in the following prior art patent documents EP1197442A3 (Applicant: Centrix Inc), U.S. Pat. No. 4,218,155 (Applicant ETABLISSEMEMTS ARMOR S.A.) U.S. Pat. No. 5,106,221 (Applicant: Plastiques RG and Gael Diot), US2001/0045374A1 (Selker), EP0411251A1 (Land O'Lakes Inc), and U.S. Pat. No. 4,648,506 (Land O'Lakes Inc).

EP197442A3 and U.S. Pat. No. 4,218,155 show examples of packs for containing produce but do not include a spatula.

By contrast, U.S. Pat. No. 5,106,221 shows a produce containing pack with an integral spatula. The spatula is fixed to a flexible tube. A cap is used to seal the aperture of the flexible tube. The spatula incorporates a cut-out region forming a C-shape to be joined to the tube on either side of the tube's cap. This prior art pack does not incorporate a peripheral flange of the tube and the spatula does not constitute an extension of the wall of the produce containing portion. Different materials are used for the wall of the flexible tube as opposed to the materials used for the spatula.

US2001/0045374A1 shows a pack for containing produce where the spatula is formed by an elongate wall portion of the produce containing region. The spatula in this configuration is not an extension of the peripheral flange. The spatula is located in effect within the flange of the pack.

EP0411251A1 shows a pack with a produce containing portion extending across the entire length of the pack without a spatula being an extension of the peripheral flange of the product. The wall of the produce containing portion is reinforced in certain locations so as to allow the pack to be used in spreading the produce.

U.S. Pat. No. 4,648,506 shows a produce containing pack of a demi-egg shape with a spatula being an extension of the peripheral flange.

### SUMMARY OF THE INVENTION

In a first broad independent aspect, the invention provides a pack comprising a produce containing portion and a spatula which in use is joined to said produce containing portion; the spatula being an extension of a wall of the produce containing portion which extends in use beyond the periphery of the produce containing portion; characterised in that the produce containing portion is a squeeze-pack incorporating one or more fold lines which allow the pack to be collapsed on itself about said lines in concertina fashion when a user squeezes the pack.

None of the multiple prior art documents shows this configuration of features. It is particularly advantageous because it allows the user to readily force the produce out of the pack by squeezing the produce containing portion of the pack. It allows the packs to be constructed of thicker materials than suggested in the prior art so that the produce is better protected during use and manufacture. It will avoid produce containing portions accidentally bursting in transport when accidental pressure is applied to the packs. It will also allow the operator to have greater control over the quantity of produce forced out of the pack as well as the velocity of the produce exiting the pack.

In a second broad independent aspect, the invention provides a pack comprising a produce containing portion and a spatula which in use is joined to said produce containing portion; the spatula being an extension of a wall of the produce containing portion which extends in use beyond the periphery of the produce containing portion; characterised in that the pack incorporates a peripheral flange; the spatula being an extension of the peripheral flange and incorporating means for reinforcing the spatula.

U.S. Pat. No. 4,649,506 does not reinforce the spatula in any way. EP0411251 opts by contrast to reinforcing the produce containing portion of the pack through two spaced apart indentations.

Reinforcing the spatula in this manner will improve the achievable lengths of the spatula as well as its ability to spread as a conventional knife. It will also be particularly advantageous because it won't have any undue stiffness in the collapsible portion of the pack as suggested in the prior art.

In an third broad independent aspect, the invention provides a pack comprising a produce containing portion and a spatula which in use is joined to said produce containing portion; the spatula being an extension of a wall of the produce containing portion which extends in use beyond the periphery of the produce containing portion; characterised in that the pack incorporates a peripheral flange; the spatula being an extension of the peripheral flange and incorporating a recess of lower depth than the produce containing portion which extends from the produce containing portion at least partially across the spatula.

This combination of features is particularly advantageous because it will allow the operator to view the quantity of produce exiting the pack as it is collapsed in use. It will also allow the control of the velocity of the produce exiting the pack. In addition, the presence of the recess will also act as a reinforcement of the spatula itself so that a greater length of spatula may be achieved without increasing the risk of it unduly breaking during use.

In a fourth broad independent aspect, the inventor provides a pack comprising a produce containing portion and a spatula which in use is joined to said produce containing portion; the spatula being an extension of a wall of the produce containing portion which extends in use beyond the periphery of the produce containing portion; characterised in that the pack incorporates a peripheral flange; the spatula being an extension of the peripheral flange and the pack further comprises a surface onto which the pack maybe stood, in use, which incorporates angled edges.

In this configuration, the pack will be supplied with stability compared to the prior art packs. This also therefore allows the packs to be stacked in a stable structure. It will also avoid deformation along a rounded edge which will mechanically lead to the pack more readily imploding.

In a fifth broad independent aspect, the invention provides a pack comprising a produce containing portion and a spatula which in use is joined to said produce containing portion; the spatula being an extension of a wall of the produce containing portion which extends in use beyond the periphery of the produce containing portion; characterised in that the spatula seals an aperture in the produce containing portion and is hinged so as to be rotatable from an aperture covering position to a spreading position.

In this configuration, by folding the spatula, at least one side surface of the spatula can itself be protected prior to use without requiring an extra layer of covering. It also allows the pack to be of greater compactness as compared to the prior art structures discussed above.

In a sixth broad independent aspect, the invention provides a pack comprising a produce containing portion and a spatula which in use is joined to said produce containing portion; the spatula being an extension of a wall of the produce containing portion; the spatula being an extension of a wall of the produce containing portion which extends in use beyond the periphery of the produce containing portion; characterised in that the produce containing portion is wedge shaped with the highest portion of the wedge substantially at the rear portion of the produce containing portion and the lowest portion of the wedge at the front portion of the produce containing portion where the produce exits the produce containing portion in use.

This configuration is particularly advantageous because it allows maximum produce to exit the pack when the pack is collapsed. It also clearly indicates where an operator would naturally apply pressure. This configuration also facilitates more rapid collapsing of the pack's wall.

In a seventh broad independent aspect, the invention provides a pack comprising a produce containing portion and a spatula which in use is joined to said produce containing portion; the spatula being an extension of a wall of the produce containing portion which extends in use beyond the periphery of the produce containing portion; characterised in that the produce containing portion is located beneath the spatula and a peel-back-able portion of the produce containing portion is located beneath the spatula. This configuration marks a complete departure from the prior art teaching that the produce containing portion extends beneath the spatula and that the peel-back-able portion of the produce containing portion is located necessarily above the spatula.

In a further subsidiary aspect, the invention provides a multi-pack comprising a plurality of packs in accordance with any of the preceding aspects and means allowing individual packs to be separable from one another through a tearing action. This would allow an array of one shot devices to be sold in a particularly practical format.

In a further subsidiary aspect, the connecting edges of each pack are at an angle one relative to the other. This may allow the pack to be joined together in a circle which reduces any risk of the packs being accidentally separated.

### BRIEF DESCRIPTION OF THE FIGURES

FIGS. 1a, b and c respectively show a plan view of a covered pack, a plan view of an uncovered pack and a side elevation of an uncovered pack in accordance with a first embodiment of the invention.

FIG. 2 shows a multi-pack based on an array of packs of the kind shown in the first embodiment of the invention.

FIGS. 3a and b show a perspective top and bottom view of a second embodiment of the invention; whilst FIG. 3c shows a single pack from a bottom perspective view.

FIGS. 4a and b show a bottom and top perspective view of a pack in accordance with a third embodiment of the invention.

FIG. 5 show a bottom and top view of a multi-pack in accordance with a third embodiment of the invention.

FIGS. 6a and b respectively show a top perspective view and a bottom perspective view of a pack in accordance with a fourth embodiment of the invention.

FIG. 7 shows a schematic part cross-sectional view of a pack in accordance with a fifth embodiment of the invention.

FIGS. 8a and b respectively show an end view and a side view of a sixth embodiment of the invention.

FIG. 9 shows a schematic cross-sectional view of a pack in accordance with a seventh embodiment of the invention.

FIG. 10 shows a schematic cross-sectional view of the pack in accordance with an eighth embodiment of the invention.

FIG. 11a shows a perspective view of a pack in accordance with a ninth embodiment of the invention; FIG. 11b shows a view of the underside of the pack of FIG. 11a.

FIG. 12 shows a perspective view of a pack in accordance with a tenth embodiment of the invention.

FIG. 13 shows a perspective view of a pack in accordance with an eleventh embodiment of the invention.

### DETAILED DESCRIPTION OF THE FIGURES

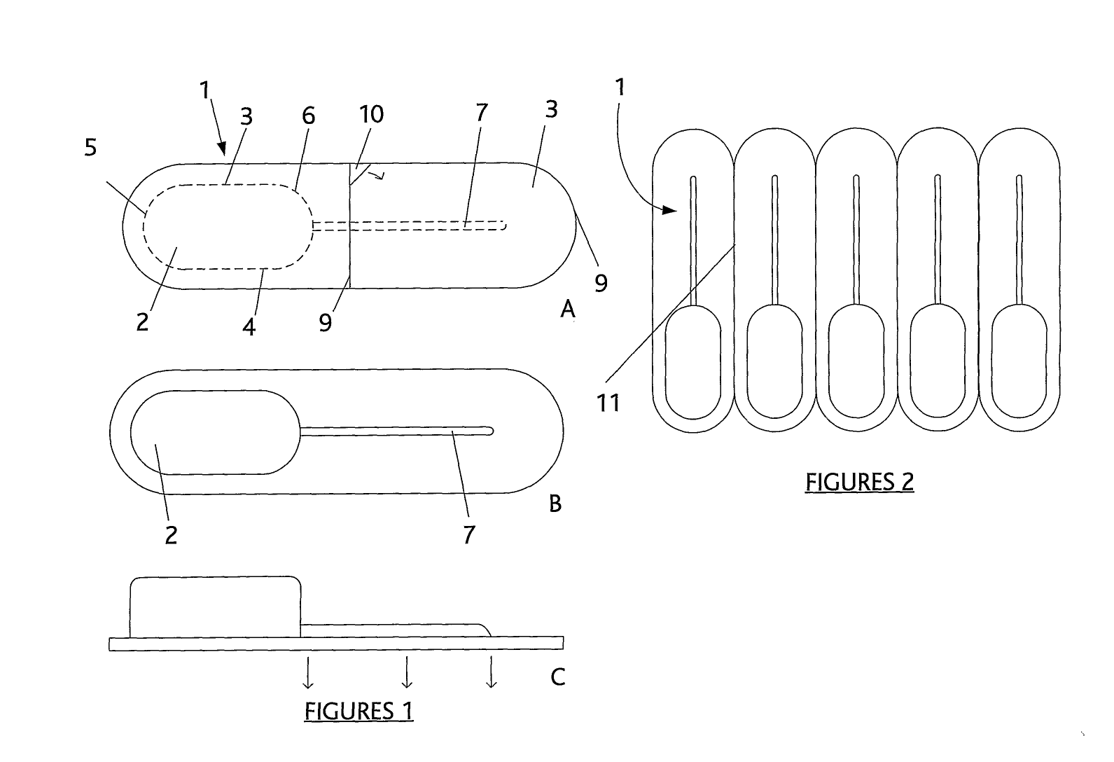

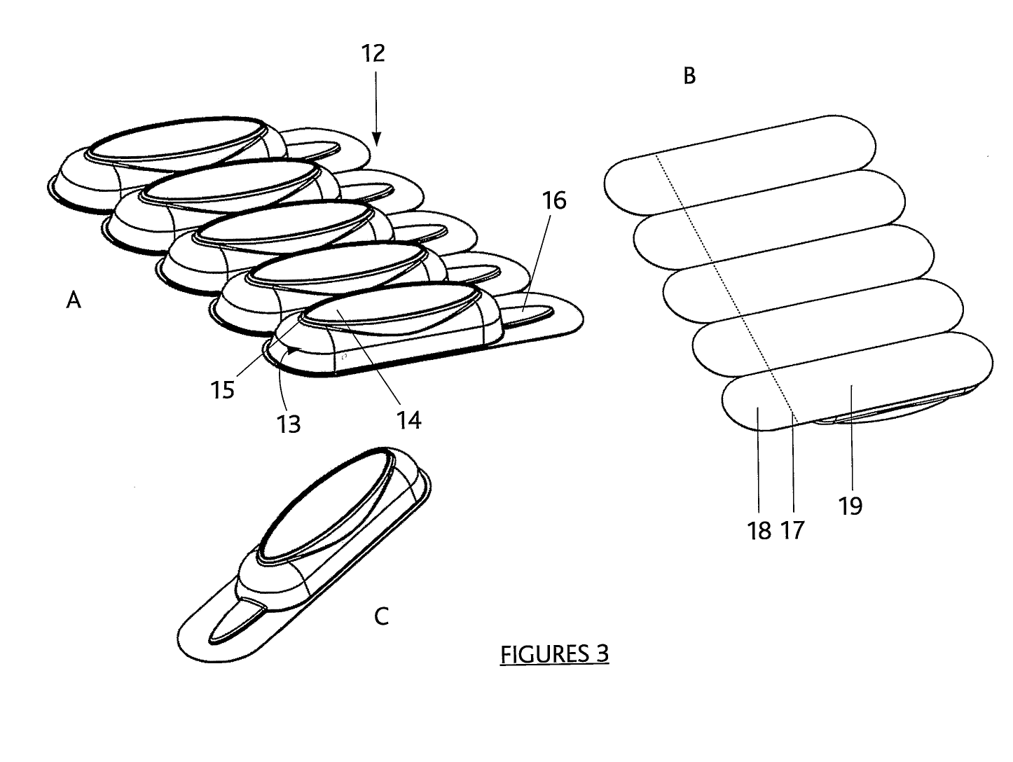

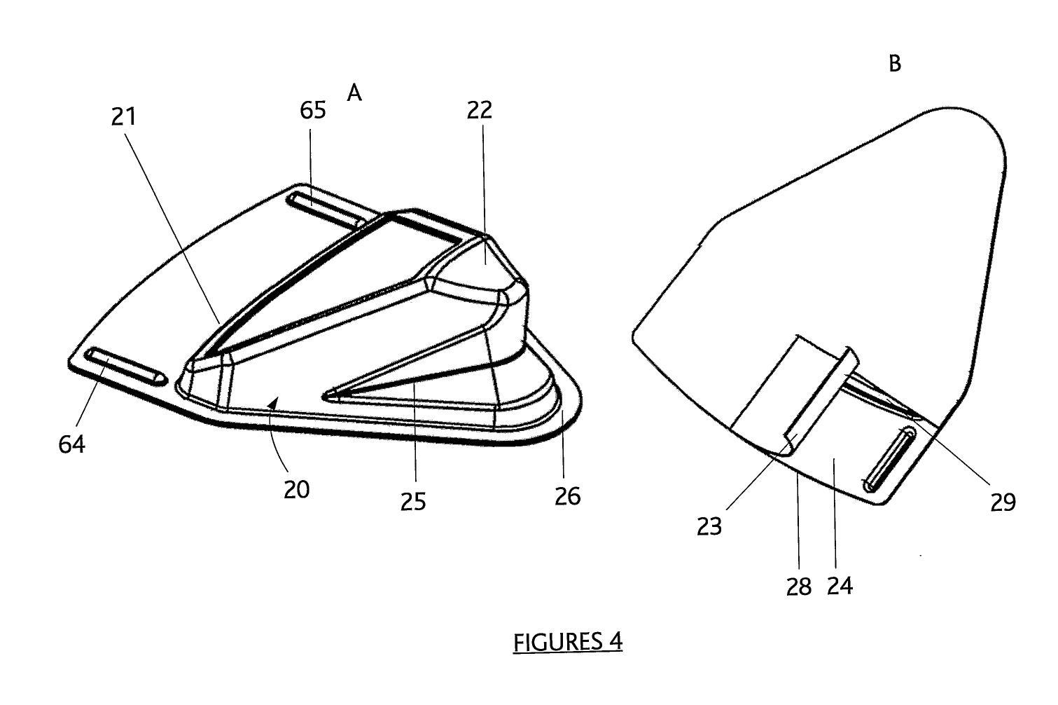

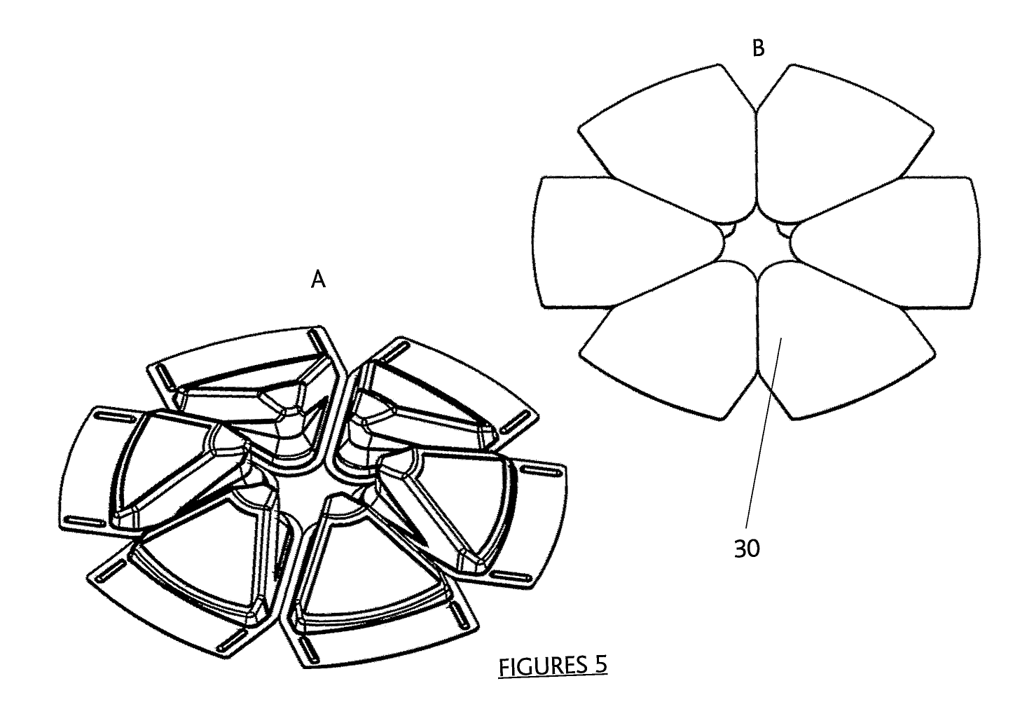

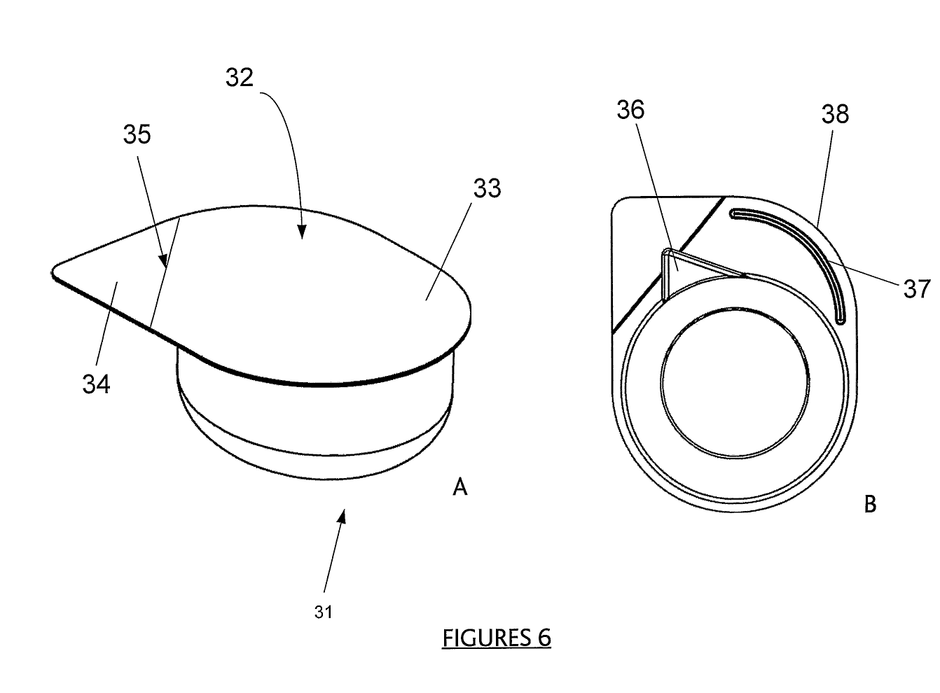

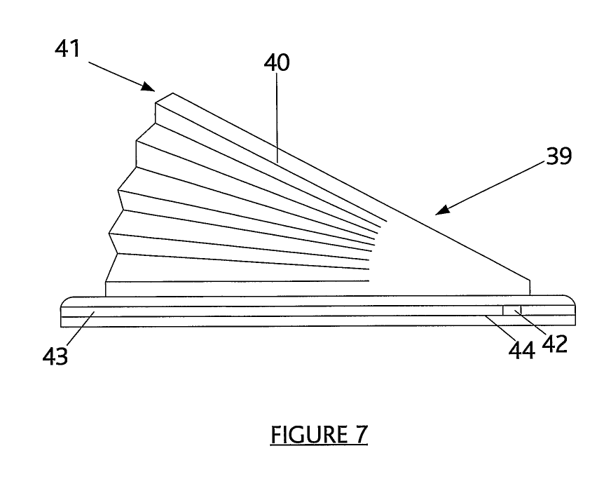

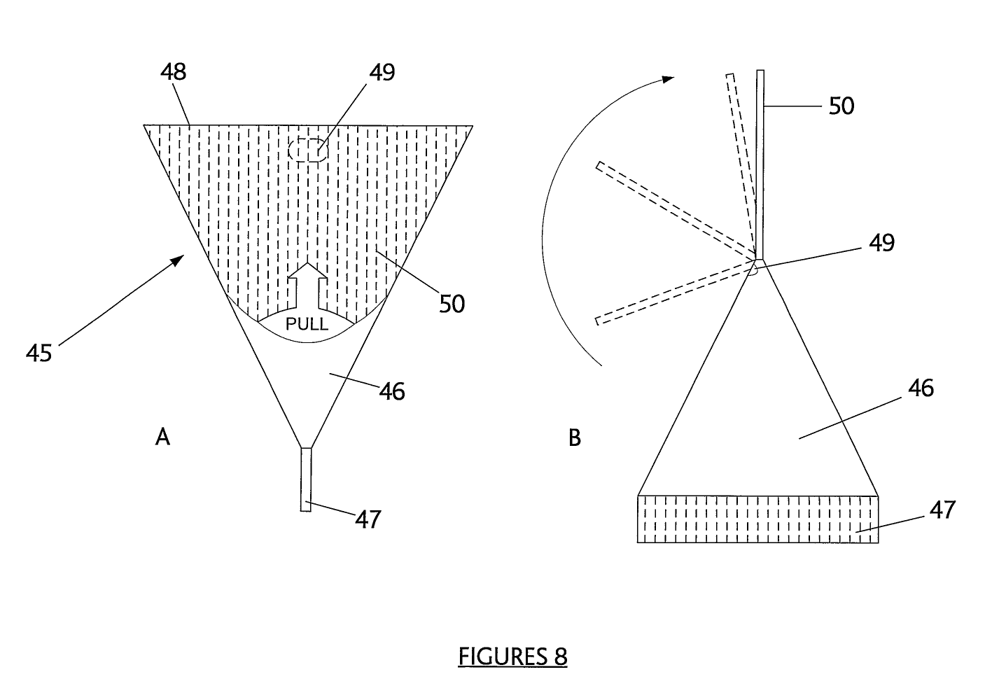

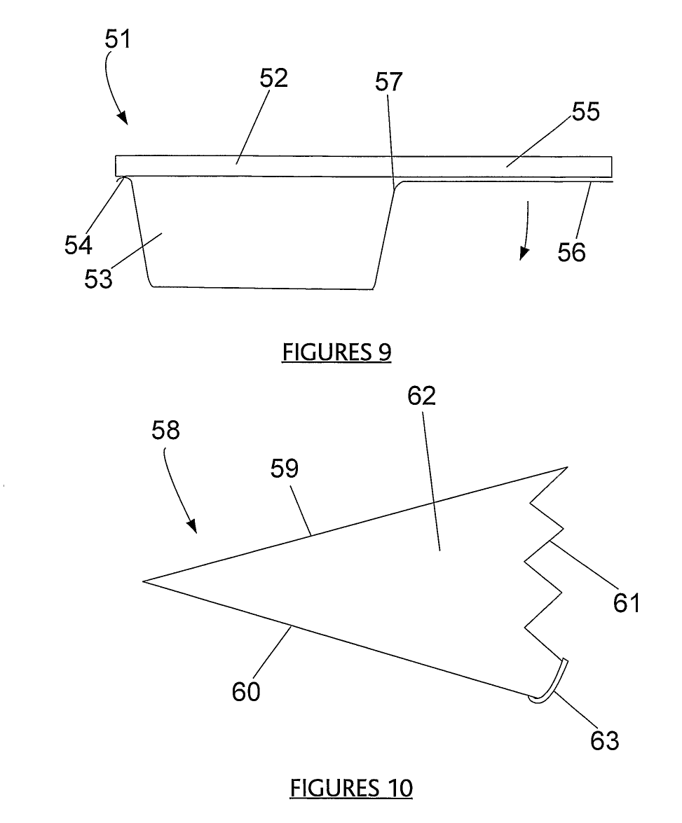

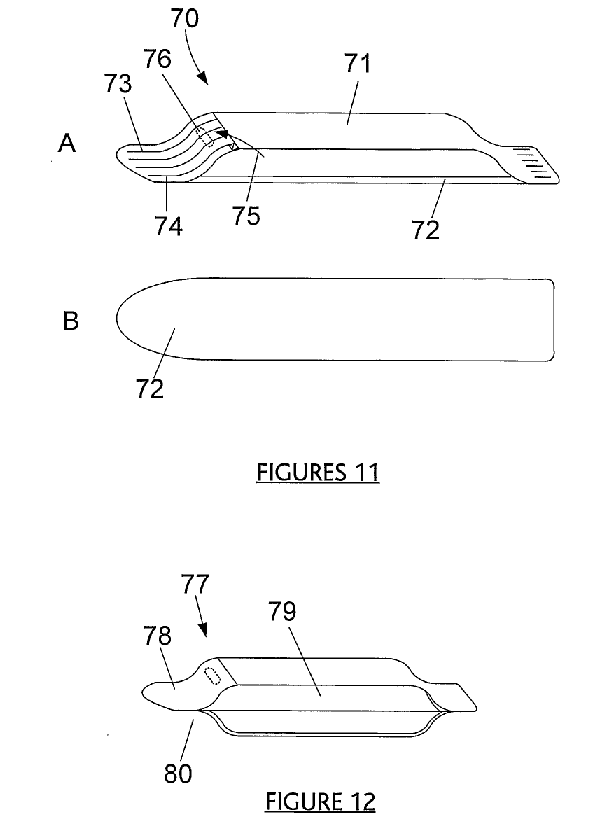

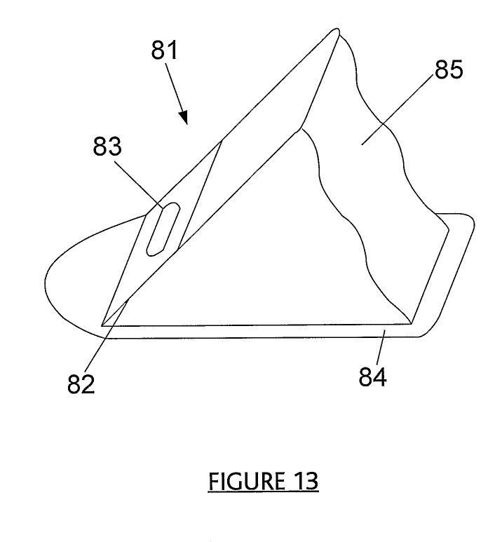

FIG. 1 shows a pack generally referenced 1 with a produce containing portion 2 and a spatula 3.

The term ‘spatula’ is to be interpreted broadly in this application in order to include a blade, a spoon, an extension and/or a projection of sufficient length to enable spreading.

The produce containing portion 2 is a single chamber recess as can be seen in FIG. 1c. The recess has two parallel wall portions 3 and 4 joined together at both extremities by rounded portions 5 and 6. The spatula 3 incorporates a trough 7 extending centrally along the spatula and from rounded portion 6 of the produce containing portion 2. The depth of trough 7 is approximately four times less than the depth of the produce containing portion 2. The trough is shown as extending along the spatula along a central line along approximately ¾ of the length of the spatula. The spatula shown in FIGS. 1a to c is terminated by a rounded end 8.

A foil cover may be provided over the produce containing portion and extending across the spatula 3. The foil cover may comprise a break such as that shown by line 9 so that the portion of the foil located on the spatula's side of the line may be removed without necessarily removing the portion of the foil located on the produce containing portion of the pack. The foil may be heat sealed to the produce containing portion whilst a sterile adhesive of known kind may also be used to secure the foil portion over the spatula. A corner region 10 may be readily releasable from the pack in order to allow a user to start peeling back the foil over the spatula from that corner without undue effort.

FIG. 1b clearly shows the interaction between produce containing portion 2 and trough 7. The article shown in FIG. 1b may be produced as a single piece plastics moulded article. The foil may be attached to this single piece article through conventional vacuum packing techniques.

FIG. 1c shows how the pack may be held for application of the produce, for example, cream cheese on a piece of bread by possibly holding upside down the pack and pressing the walls of the produce containing portion so as to force the produce out through the passage formed by the foil portion above the produce and the trough. In the mode of use shown, the produce would exit as shown by the arrows from the trough to a spreading position.

FIG. 2 shows an array of packs 1 joined together by their longest side 11. The joint between each pack may be perforated or weakened in any other known form in order to allow an operator to tear one pack from the multi-pack at a time.

FIG. 3a shows a multi-pack 12 with a number of packs such as that referenced 13. Each pack has a foot 14 with a rim 15 of an elongate oval shape and sufficiently planar to allow each pack to be stood on their foot with stability.

Similarly to the embodiment shown in FIG. 2, the multi-packs shown are joined by their longest side in order to allow them to be transported without risking the individual packs to be accidentally detached whilst simultaneously allowing an operator to separate a pack from the multi-pack such as that shown in FIG. 3c.

Each pack has a spatula recess 16 which is also of partial oval shape in order to allow greater content to be squeezed from the produce containing portion onto the spatula of each pack when in use.

As shown in FIG. 3, a tear line 17 may be provided between two foil portions 18 and 19.

FIG. 4a shows the underneath of a pack 20 of essentially triangular shape. Pack 20 is also substantially wedge-shaped having a greater depth at the apex of the triangle as compared to the height of the container at end 21. The pack is truncated by a face 22 at its uppermost extremity which will allow an operator to intuitively find surface 22 in order to apply a pressure to squeeze the produce out of the container when spatula cover 23 of spatula 24 is uncovered as shown in FIG. 4b. The wall of the produce containing portion of pack 20 points inwards at line 25 in order to allow the pack to collapse when an operator applies pressure on surface 22 in a similar manner as a concertina arrangement would.

The produce containing portion incorporates a rim 26 in order to allow the attachment through heat sealing or any other appropriate means of the produce foil covering 27.

Spatula 24 extends beyond the periphery of the produce containing portion as can be seen in both FIGS. 4a and 4b. Spatula 24 is substantially of rectangular shape in this embodiment with a slightly bowed outer edge 28. As can be seen in FIG. 4b, when foil 23 is peeled back, the food containing portion is uncovered by a narrow channel 29.

FIGS. 5a and 5b show the pack described in detail with reference to FIGS. 4a and 4b in a multi-pack arrangement. As can be seen, one of the sides of the triangular portion such as that referenced 30 joins a neighbouring similar pack. Joining six packs of this kind together in this manner forms a closed loop of packs.

FIGS. 6a and 6b show a further pack 31 whose produce containing portion 32 is of essentially cylindrical shape. A rim 33 extends as part of the produce containing portion as in similar packs available in the market place. One side of the pack is provided with an extension of that rim which acts as a spatula 34.

The spatula has a foil covering which may be removed by an operator. The produce will escape pack 31 through region 35 as and when an operator applies pressure on the produce containing portion. The spatula may then be used to spread the produce on any appropriate article. Region 35 may be part of a dispensing trough 36 which is joined to produce containing portion 32 whilst being shallower than this portion. A rib 37 may be provided in close proximity to the edge 38 of the pack and designed to follow the geometry of said edge over a limited corner portion of the edge of the pack.

FIG. 7 shows a pack 39 with a collapsible wedge-shaped produce containing portion 40 which has a succession of inwardly pointing regions such as that referenced 41 arranged like a concertina to avoid any undue resistance from the structure of the pack to the pressure applied by an operator. An aperture 42 may be provided in a cover membrane 43 in order to allow the passage of produce when pressure is applied on the pack when covering foil 44 is peeled back.

FIG. 8a shows a pack 45 of a small scale pillow case type or tubular design. The produce being contained by a tube 46 sealed at one end 47 as a conventional tube. At the opposite extremity 48, an aperture 49 is provided in the tube which may be uncovered by rotating flap 50 from its closed (as shown in FIG. 8a) to its fully opened position (as shown in FIG. 8b). Ends 47 and 48 can be perpendicular one relative to the other.

FIG. 9 shows a pack generally referenced 51 with a rigid or bendable spatula 52 extending across the entire length of the pack. The produce containing portion 53 is attached to the underneath of the spatula by a peripheral seal 54 of known kind. The front spatula portion 55 is covered on the underside by a membrane 56 which may be peeled back in order to open the produce containing portion at region 57.

FIG. 10 shows a pack generally referenced 58 with two oppositely located rigid or bendable spatula members 59 and 60. A concertina member 61 forms part of the enclosure surrounding the produce in the produce containing portion 62. A closure member 63 may be located between the spatula member 60 and the concertina member 61 which may be removed in use to allow produce to exit the pack.

In this specification, the term “peripheral flange” may signify the entire periphery of the pack or only a portion of the periphery.

In the previous embodiments several examples of means for reinforcing the spatula have been presented such as trough 16, element 7 and 37 as well as trough 36. The embodiment of FIG. 4 also presents reinforcing means as part of the spatula such as reinforcing means 64 and 65 which are located at distal extremities of the spatula.

The term “angled edges” of the surface onto which the pack is stood includes any angle other than a substantially rounded edge.

FIG. 11a shows a pack 70 with a product containing portion 71 made in the form of a flexible (squeezable) blister in its upper portion. The lower portion 72 is formed of a relatively rigid plate. Plate 72 may be of the thickness of a yoghurt container. Area 73 is shown with an array of parallel lines 74 forming a peel off section in the direction shown by arrow 75. Once the peel off section is peeled back, it reveals a hole 76 through which produce exits the pack when an operator squeezes the produce containing portion. The upper portion of the pack may be formed of a flexible material such as the material used in aluminium pillow case drink packs such as those sold under the trade mark “Capri Sun”.

FIG. 11b shows the underside portion 72 of the pack. This rigid portion acts as the spatula.

A peel off portion 73 of this pack may only be partially removable with a portion which remains attached to the pack to avoid leaving small bits of litter.

FIG. 12 shows a pack 77 with a peel off portion 78 of the kind described with reference to FIG. 11. This pack may be of the so called pillow case form with a material similar to the “Capri Sun” (Trade Mark) drink packs. The produce containing portion 79 is almost entirely flexible whilst end portion 80 has sufficient flexibility to be used as a spatula.

FIG. 13 shows a pack 81 with a peel-off portion 82 revealing a hole 83. The underside 84 is designed to have a slightly stiffer function than product containing portion 85 which may be made of material to allow it to collapse when squeezed.

1. A pack comprising a produce containing portion and a spatula which in use is joined to said produce containing portion; the spatula being an extension of a wall of the produce containing portion which extends in use beyond the periphery of the produce containing portion; the pack incorporating one or more of the following features:
a) the produce containing portion is a squeeze-pack incorporating one or more fold lines which allow the pack to be collapsed on itself about said lines in concertina fashion when a user squeezes the pack;
b) a peripheral flange; the spatula being an extension of the peripheral flange and incorporating means for reinforcing the spatula;
c) a peripheral flange; the spatula being an extension of the peripheral flange and incorporating a recess of lesser depth than the produce containing portion which extends from the produce containing portion at least partially across the spatula;
d) a peripheral flange; the spatula being an extension of the peripheral flange and the pack further comprises a surface onto which the pack may be stood, in use, which incorporates angled edges;
e) the spatula seals an aperture in the produce containing portion and is hinged so as to be rotatable from an aperture covering position to a spreading position;
f) the produce containing portion is wedge shaped with the highest portion of the wedge substantially at the rear portion of the produce containing portion and the lowest portion of the wedge at the front portion of the produce containing portion where the produce exits the produce containing portion in use; and
g) the produce containing portion is located beneath the spatula and a peel-back-able portion of the produce containing portion is located beneath the spatula.

2. A multi-pack comprising a plurality of packs in accordance with claim 1 and means allowing individual packs to be separable from one another through a tearing action.

3. A multi-pack according to claim 2, wherein the connecting edges of each pack are at an angle one relative to the other.

4. (canceled)
